(19) United States
(12) Patent Application Publication
(10) Pub. No.: US 2024/0384913 A1
(43) Pub. Date: Nov. 21, 2024

(54) ELECTRONIC APPARATUS FOR MANAGING WATER TANK AND CONTROL METHOD THEREOF

(71) Applicant: SAMSUNG ELECTRONICS CO., LTD., Suwon-si (KR)

(72) Inventors: Kyungtae KO, Suwon-si (KR); Jungwon PARK, Suwon-si (KR); Hyunseo JANG, Suwon-si (KR); Jin JEONG, Suwon-si (KR)

(73) Assignee: SAMSUNG ELECTRONICS CO., LTD., Suwon-si (KR)

(21) Appl. No.: 18/658,175

(22) Filed: May 8, 2024

Related U.S. Application Data
(63) Continuation of application No. PCT/KR2024/003054, filed on Mar. 8, 2024.

(30) Foreign Application Priority Data
May 18, 2023 (KR) 10-2023-0064422
Jul. 26, 2023 (KR) 10-2023-0097462

(51) Int. Cl. F25C 1/25

(52) U.S. Cl. CPC F25C 1/25; F25C 2400/10; F25C 2400/14; F25C 2600/04; F25C 2700/04

(57) ABSTRACT

An electronic apparatus including a water tank that is mountable to the electronic apparatus; a water tank mount sensor configured to output a signal indicating whether the water tank is mounted to the electronic apparatus; and at least one processor configured to identify a mounted state of the water tank based on the signal output by the water tank mount sensor, and provide a guide message for a user for managing the water tank, based on the identified mounted state and a duration of the mounted state.

### CROSS-REFERENCE TO RELATED APPLICATIONS

This application is a continuation application, under 35 U.S.C. § 111 (a), of PCT/KR2024/003054, filed on Mar. 8, 2024, at the Korean Intellectual Property Receiving Office, and claims priority under 35 U.S.C. § 119 to Korean Patent Application No. 10-2023-0064422, filed on May 18, 2023 at the Korean Intellectual Property Office, and Korean Patent Application No. 10-2023-0097462, filed on Jul. 26, 2023 at the Korean Intellectual Property Office, the disclosures of each of which are incorporated by reference herein in their entireties.

### BACKGROUND

### 1. Field

The disclosure relates to an electronic apparatus and a control method thereof, and more particularly to an electronic apparatus for managing a water tank and a control method thereof.

### 2. Description of Related Art

With developments in electronic technology, electronic apparatuses providing various functions are being developed. Specifically, a refrigerator may automatically provide water to a user or each configuration of the refrigerator by including various water tanks.

For example, the refrigerator may include at least one of a water tank for providing water to the user and a water tank for providing water to each configuration of the refrigerator.

The water tank for providing water to the user may be automatically filled with water through an autofill function. Here, the autofill function may be a function which automatically fills water if a water tank is placed in a dispenser attached to the refrigerator.

The water tank for providing water to each configuration of the refrigerator may be, for example, a water tank for supplying water for ice-making. The water tank for supplying water for ice-making may be filled with water in a non-plumbing method and in a plumbing method. The non-plumbing method may be a method by which the user fills the water tank with water directly, and hygiene management may be carried with autonomous cleaning by the user. The plumbing method may be a method of providing water by connecting to a water pipe, and the method may include using a filter and guiding the user on a replacement period by managing filter usage.

As described above, water tanks applied with the autofill function and water tanks using the non-plumbing method may depend on the autonomous cleaning by the user, and the water tank may not be hygienically managed if the water tank is not frequently cleaned or if the water tank is neglected in an unused state for long periods of time.

### SUMMARY

Aspects of embodiments of the disclosure will be set forth in part in the description which follows and, in part, will be apparent from the description, or may be learned by practice of the presented embodiments.

According to an embodiment of the disclosure, an electronic apparatus includes a water tank that is mountable to the electronic apparatus; a water tank mount sensor configured to output a signal indicating whether the water tank is mounted to the electronic apparatus; and at least one processor configured to identify a mounted state of the water tank based on the signal output by the water tank mount sensor, and provide a guide message for a user for managing the water tank, based on the identified mounted state and a duration of the mounted state.

According to an embodiment of the disclosure, the at least one processor may be configured to, based on a first duration time being passed with the identified mounted state being a state that the water tank is not mounted to the electronic apparatus, provide a first guide message for the user for managing the water tank, and, based on a second duration time being passed with the identified mounted state being a state that the water tank is mounted to the electronic apparatus, provide a second guide message for the user for managing the water tank.

According to an embodiment of the disclosure, the electronic apparatus may further include an environment sensor configured to output a signal indicating temperature and humidity outside the electronic apparatus. The at least one processor may be configured to identify the temperature and humidity outside the electronic apparatus based on the signal output by the environment sensor, and, based on at least one of the identified temperature being greater than a threshold temperature and the identified humidity being greater than a threshold humidity, change the first duration time to a third duration time being passed with the identified mounted state being a state that the water tank is not mounted, the third duration time being shorter than the first duration time.

According to an embodiment of the disclosure, the electronic apparatus may further include a water level sensor configured to output a signal indicating a water level of the water tank. The processor may be configured to identify the water level of the water tank based on the signal output by the water level sensor, based on a fourth duration time being passed with the identified mounted state being a state that the identified water level of the water tank is greater than a threshold value, provide the second guide message for the user for managing the water tank, and, based on a fifth duration time being passed with the identified mounted state being a state that the identified water level of the water tank is greater than the threshold value, the fifth duration time being longer than the fourth duration time, provide a third guide message for the user for managing the water tank.

According to an embodiment of the disclosure, the processor may be configured to identify an execution state of a first function which is a function for supplying water to the water tank, and, based on the execution state of the first function being changed, provide the guide message for the user for managing the water tank.

According to an embodiment of the disclosure, the processor may be configured to, based on the first function being turned-on and a first duration time being passed with the identified mounted state being a first state, provide a first guide message for the user for managing the water tank, based on the first function being turned-on and a second duration time being passed with the identified mounted state being a second state, provide a second guide message for the user for managing the water tank, and, based on the first function being turned-off, provide the second guide message for the user for managing the water tank.

According to an embodiment of the disclosure, the water tank that is mountable to the electronic apparatus may be a first water tank, the electronic apparatus may further include a second water tank, and the at least one processor may be configured to identify an execution state of a first function which is a function for supplying water from the second water tank to the first water tank, and provide a guide message for a user for managing the second water tank based on the execution state of the first function being changed.

According to an embodiment of the disclosure, the processor may be configured to identify an execution state of a second function which is a function for supplying water from the second water tank to another configuration in the electronic apparatus, and, based on the execution state of the second function being changed, provide the guide message for the user for managing the second water tank.

According to an embodiment of the disclosure, the second function may be a function for using an ice maker in the electronic apparatus by using water supplied from the second water tank. The processor may be configured to provide the guide message for the user for managing the second water tank based on ice generated by the ice maker.

According to an embodiment of the disclosure, the electronic apparatus may further include a display and a speaker. The processor may be configured to display the guide message through the display, and/or output the guide message in sound through the speaker.

According to an embodiment of the disclosure, the electronic apparatus may further include a communication interface. The processor may be configured to control the communication interface to transmit the guide message to a user terminal device.

According to an embodiment of the disclosure, provided is a control method of an electronic apparatus including a water tank that is mountable to the electronic apparatus and a water tank mount sensor configured to output a signal indicating whether the water tank is mounted to the electronic apparatus, the method including, by the electronic apparatus, identifying a mounted state of a water tank based on the signal output by the water tank mount sensor; and providing a guide message for a user for managing the water tank, based on the identified mounted state and a duration of the mounted state.

According to an embodiment of the disclosure, the providing of the guide message may include, based on a first duration time being passed with the identified mounted state being a state that the water tank is not mounted to the electronic apparatus, providing a first guide message for the user for managing the water tank, and, based on a second duration time being passed with the identified mounted state being a state that the water tank is mounted to the electronic apparatus, providing a second guide message for the user for managing the water tank.

According to an embodiment of the disclosure, the electronic apparatus may include an environment sensor configured to output a signal indicating temperature and humidity outside the electronic apparatus, and the method may further include, by the electronic apparatus, identifying the temperature and humidity outside the electronic apparatus based on the signal output by the environment sensor; and based on at least one of the identified temperature being greater than a threshold temperature and the identified humidity being greater than a threshold humidity, changing the first duration time to a third duration time being passed with the identified mounted state being a state that the water tank is not mounted, the third duration time being shorter than the first duration time.

According to an embodiment of the disclosure, the electronic apparatus may include a water level sensor configured to output a signal indicating a water level of the water tank, and the method may further include, by the electronic apparatus, identifying the water level of the water tank based on the signal output by the water level sensor; based on a fourth duration time being passed with the identified mounted state being a state that the identified water level of the water tank is greater than a threshold value, providing the second guide message for the user for managing the water tank; and based on a fifth duration time being passed with the identified mounted state being a state that the identified water level of the water tank is greater than the threshold value, providing a third guide message for the user for managing the water tank.

### BRIEF DESCRIPTION OF THE DRAWINGS

These and/or other embodiments of the disclosure will become apparent and more readily appreciated from the following description of embodiments, taken in conjunction with the accompanying drawings of which:

FIG. 1 is a block diagram illustrating a configuration of an electronic apparatus according to an embodiment of the disclosure;

FIG. 2 is a block diagram illustrating a detailed configuration of an electronic apparatus according to an embodiment of the disclosure;

FIG. 3 is a diagram illustrating a system associated with an autofill function according to an embodiment of the disclosure;

FIG. 4 is a diagram illustrating a system providing a guide message according to an embodiment of the disclosure;

FIG. 5 to FIG. 8 are flowcharts illustrating an operation of providing a guide message according to various embodiments of the disclosure; and

FIG. 9 is a flowchart illustrating a control method of an electronic apparatus according to an embodiment of the disclosure.

### DETAILED DESCRIPTION

The exemplary embodiments of the present disclosure may be diversely modified. Accordingly, specific exemplary embodiments are illustrated in the drawings and are described in detail in the detailed description. However, it is to be understood that the present disclosure is not limited to a specific exemplary embodiment, but includes all modifications, equivalents, and substitutions without departing from the scope and spirit of the present disclosure. Also, well-known functions or constructions are not described in detail since they would obscure the disclosure with unnecessary detail.

An object of the disclosure is in providing an electronic apparatus for managing hygiene of a water tank by guiding a user of washing the water tank provided at the electronic apparatus and a control method thereof.

The disclosure will be described in detail below with reference to the accompanying drawings.

Terms used in describing one or more embodiments of the disclosure are general terms selected that are currently widely used considering their function herein. However, the terms may change depending on intention, legal or technical interpretation, emergence of new technologies, and the like of those skilled in the related art. Further, in certain cases, there may be terms arbitrarily selected, and in this case, the meaning of the term will be disclosed in greater detail in the corresponding description. Accordingly, the terms used herein are not to be understood simply as its designation but based on the meaning of the term and the overall context of the disclosure.

In the disclosure, expressions such as “have,” “may have,” “include,” “may include,” or the like are used to designate a presence of a corresponding characteristic (e.g., elements such as numerical value, function, operation, or component), and not to preclude a presence or a possibility of additional characteristics.

The expression “at least one of A and/or B” is to be understood as indicating any one of “A” or “B” or “A and B.”

For example, the expression “at least one of A and B” includes any of the following: A, B, A and B. The expression “at least one of A, B, and C” includes any of the following: A, B, C, A and B, A and C, B and C, A and B and C.

For example, the expression “at least one of A or B” includes any of the following: A, B, A and B. The expression “at least one of A, B, and C” includes any of the following: A, B, C, A and B, A and C, B and C, A and B and C.

Expressions such as “first,” “second,” “1st,” “2nd,” and so on used herein may be used to refer to various elements regardless of order and/or importance, and it should be noted that the expressions are merely used to distinguish an element from another element and not to limit the relevant elements.

A singular expression includes a plural expression, unless otherwise specified. It is to be understood that the terms such as “form” or “include” are used herein to designate a presence of a characteristic, number, step, operation, element, component, or a combination thereof, and not to preclude a presence or a possibility of adding one or more of other characteristics, numbers, steps, operations, elements, components or a combination thereof.

In the disclosure, the term “user” may refer to a person using an electronic device or an apparatus (e.g., artificial intelligence electronic apparatus) using an electronic device.

The disclosure will be described in greater detail below with reference to the accompanied drawings.

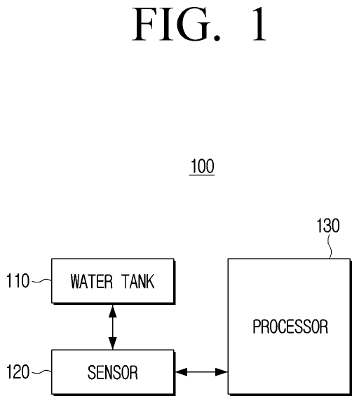

FIG. 1 is a block diagram illustrating a configuration of an electronic apparatus 100 according to an embodiment of the disclosure. Referring to FIG. 1, the electronic apparatus 100 may include a water tank 110, a sensor 120, and a processor 130.

The electronic apparatus 100 may be an apparatus including the water tank 110. For example, the electronic apparatus 100 may be a refrigerator including the water tank 110 inside thereof, but is not limited thereto, and the electronic apparatus 100 may be any apparatus so long as it is an apparatus which includes an attachable or detachable water tank 110.

The water tank 110 may be a device for storing water. For example, the water tank 110 may provide water to the user or provide water to each configuration of the electronic apparatus 100. In an example, the water tank 110 may include a first water tank for providing water to the user and a second water tank for providing water to each configuration of the electronic apparatus 100. Here, each configuration of the electronic apparatus 100 may include the first water tank. In this case, the second water tank may provide water to the first water tank.

However, the above is not limited thereto, and the water tank 110 may be implemented as one water tank which provides water to the user and each configuration of the electronic apparatus 100.

The water tank 110 may be implemented in a form attachable to or detachable from the electronic apparatus 100.

The sensor 120 may identify whether or not the water tank 110 is mounted. For example, the sensor 120 may include a weight sensor, and identify whether or not the water tank 110 is mounted by sensing a weight of the water tank 110 when the water tank 110 is mounted. Alternatively, the sensor 120 may be implemented in a form that senses fine current flowing through contact with the water tank 110. In this case, the processor 130 may identify the water tank 110 as having been mounted when fine current is sensed.

However, the above is not limited thereto, and the sensor 120 may be implemented to any form so long as it can identify whether or not the water tank 110 is mounted.

The sensor 120 may further include, in addition to the sensor which identifies whether or not the water tank 110 is mounted, at least one of a temperature sensor which senses temperature outside the electronic apparatus 100, a humidity sensor which senses humidity outside the electronic apparatus 100, a water level sensor which identifies a water level of the water tank 110, and an overflow sensor which senses whether water overflows from the water tank 110.

However, the above is not limited thereto, and the sensor 120 may further include the weight sensor in place of the water level sensor, and the processor 130 may identify the water level of the water tank 110 based on the weight of the water tank 110 sensed through the weight sensor.

The processor 130 may control the overall operation of the electronic apparatus 100. Specifically, the processor 130 may control the overall operation of the electronic apparatus 100 by being connected with each configuration of the electronic apparatus 100. For example, the processor 130 may control an operation of the electronic apparatus 100 by being connected with configurations such as the sensor 120, and a memory (not shown).

At least one processor 130 may include at least one of a central processing unit (CPU), a graphics processing unit (GPU), an accelerated processing unit (APU), a many integrated core (MIC), a neural processing unit (NPU), a hardware accelerator, or a machine learning accelerator. The at least one processor 130 may control one or a random combination from among other elements of the electronic apparatus 100, and perform an operation associated with communication or data processing. The at least one processor 130 may execute at least one program or instruction stored in the memory. For example, the at least one processor 130 may perform, by executing at least one instruction stored in the memory, a method according to an embodiment of the disclosure.

When a method according to an embodiment of the disclosure includes a plurality of operations, the plurality of operations may be performed by one processor, or performed by a plurality of processors. For example, when a first operation, a second operation, and a third operation are performed by a method according to an embodiment, the first operation, the second operation, and the third operation may all be performed by a first processor, or the first operation and the second operation may be performed by the first processor (e.g., a generic-purpose processor) and the third operation may be performed by a second processor (e.g., an artificial intelligence dedicated processor).

The at least one processor 130 may be implemented as a single core processor that includes one core, or implemented as at least one multicore processor that includes a plurality of cores (e.g., a homogeneous multicore or a heterogeneous multicore). If the at least one processor 130 is implemented as a multicore processor, each of the plurality of cores included in the multicore processor may include a memory inside the processor such as a cache memory and an on-chip memory, and a common cache shared by the plurality of cores may be included in the multicore processor. In addition, each of the plurality of cores (or a portion from among the plurality of cores) included in the multicore processor may independently read and perform a program command for implementing a method according to an embodiment of the disclosure, or read and perform a program command for implementing a method according to an embodiment of the disclosure due to a whole (or a portion) of the plurality of cores being interconnected.

When a method according to an embodiment of the disclosure includes a plurality of operations, the plurality of operations may be performed by one core from among the plurality of cores or performed by the plurality of cores included in the multicore processor. For example, when a first operation, a second operation, and a third operation are performed by a method according to an embodiment, the first operation, the second operation, and the third operation may all be performed by a first core included in the multicore processor, or the first operation and the second operation may be performed by the first core included in the multicore processor and the third operation may be performed by a second core included in the multicore processor.

According to the embodiments of the disclosure, the at least one processor 130 may refer to a system on chip (SoC), a single core processor, or a multicore processor in which the at least one processor and other electronic components are integrated or a core included in the single core processor or the multicore processor, and the core herein may be implemented as the CPU, the GPU, the APU, the MIC, the NPU, the hardware accelerator, the machine learning accelerator, or the like, but the embodiments of the disclosure are not limited thereto. However, for convenience of description, an operation of the electronic apparatus 100 will be described below using the expression ‘processor 130.’

The processor 130 may identify a mounted state of the water tank 110 based on a signal of the sensor 120, and provide a guide message for managing the water tank 110 based on the mounted state of the water tank 110 and a duration of the mounted state of the water tank 110.

For example, the processor 130 may provide a first guide message for managing the water tank 110 if a first time is passed with the water tank 110 not mounted to the electronic apparatus 100, and provide a second guide message for managing the water tank 110 if a second time is passed with the water tank 110 mounted to the electronic apparatus 100. Here, the first guide message may be “Please store the water tank at the electronic apparatus.”, and the second guide message may be “Please periodically clean the water tank.”

The sensor 120 may include a first sensor 120 configured to identify whether or not the water tank 110 is mounted and a second sensor 120 configured to identify temperature and humidity outside the electronic apparatus 100, and the processor 130 may identify the temperature and humidity outside the electronic apparatus 100 based on a signal of the second sensor 120, and change the first time to a third time which is shorter than the first time based on at least one of the temperature being greater than or equal to a threshold temperature, or the humidity being greater than or equal to a threshold humidity.

For example, the processor 130 may provide the first guide message for managing the water tank 110 if 10 minutes has passed with the water tank 110 not mounted to the electronic apparatus 100, but the 10 minutes may be changed to 5 minutes based on at least one of the temperature being greater than or equal to the threshold temperature or the humidity being greater than or equal to the threshold humidity. In this case, the processor 130 may provide the first guide message for managing the water tank 110 if 5 minutes has passed with the water tank 110 not mounted to the electronic apparatus 100.

The sensor 120 may further include a third sensor 120 configured to identify the water level of the water tank 110, and the processor 130 may provide the second guide message if a fourth time is passed with the water level of the water tank 110 being greater than or equal to a threshold value based on a signal of the third sensor 120, and provide a third guide message for managing the water tank 110 if a fifth time which is longer than the fourth time is passed with the water level of the water tank 110 being greater than or equal to the threshold value.

For example, the processor 130 may provide a guide message such as “Please periodically clean the water tank.” if 15 days have passed with the water level of the water tank 110 being greater than or equal to the threshold value, and provide a guide message such as “The water tank has not been used for a long period of time. Please set to off.” if 30 days have passed with the water level of the water tank 110 being greater than or equal to the threshold value.

The processor 130 may identify an execution state of a first function which is a function for supplying water to the water tank 110, and provide a guide message if the execution state of the first function is changed.

For example, the processor 130 may provide a guide message for managing the water tank 110 if the execution state of the autofill function is changed from a turned-off state to a turned-on state.

The processor 130 may provide the first guide message for managing the water tank 110 if the first function is turned-on and the first time is passed with the water tank 110 in a first state, provide the second guide message for managing the water tank 110 if the first function is turned-on and the second time is passed with the water tank 110 in a second state, and provide the second guide message if the first function is turned-off.

For example, the processor 130 may provide a guide message such as “Please store the water tank at the electronic apparatus.” if the autofill function is turned-on and the first time is passed with the water tank 110 not being mounted, provide a guide message such as “Please periodically clean the water tank.” if the autofill function is turned-on and the second time is passed with the water tank 110 not being mounted, and provide a guide message such as “Please periodically clean the water tank.” if the autofill function is turned-off.

The water tank 110 may include a first water tank 110 and a second water tank 110, and the processor 130 may identify the execution state of the first function which is a function for supplying water from the second water tank 110 to the first water tank 110, and provide another guide message for managing the second water tank 110 if the execution state of the first function is changed.

For example, the water tank 110 may include the first water tank for providing water to the user and the second water tank for providing water to each configuration of the electronic apparatus 100, and the processor 130 may identify the execution state of the first function which is a function for supplying water from the second water tank 110 to the first water tank 110, and provide another guide message such as “Please periodically clean the second water tank.” if the execution state of the first function is changed from the turned-off state to the turned-on state.

The processor 130 may identify an execution state of a second function which is a function for supplying water to configurations included in the electronic apparatus 100 from the second water tank 110, and provide another guide message if the execution state of the second function is changed.

For example, the second function may be a function for using an ice maker included in the electronic apparatus 100 by using the water supplied from the second water tank, and another guide message such as “Please periodically clean the second water tank.” may be provided if a function using the ice maker (or an ice maker function) is turned-on.

Here, the processor 130 may also provide another guide message based on ice generated by the ice maker. For example, the processor 130 may provide another guide message such as “Please fill with water after cleaning the second water tank.” if the ice generated by the ice maker is not fully filled. Alternatively, the processor 130 may provide another guide message such as “Please periodically clean the second water tank.” if the ice generated by the ice maker is fully filled.

The processor 130 may provide another different guide message based on the ice generated by the ice maker being fully filled or a fully filled duration. For example, the processor 130 may provide another guide message such as “Please periodically clean the second water tank.” if the ice generated by the ice maker is fully filled and 15 days have passed, and provide another guide message such as “The second water tank has not been used for a long period of time. Please set to off.” if the ice generated by the ice maker is fully filled and 30 days have passed.

The electronic apparatus 100 may further include a display and a speaker, and the processor 130 may display a guide message through the display, or output the guide message in sound through the speaker.

Alternatively, the electronic apparatus 100 may further include a communication interface, and the processor 130 may control the communication interface to transmit the guide message to a user terminal device.

In the above, descriptions based mainly on the mounted state of the water tank 110 have been provided, but the guide message may be provided under any other conditions.

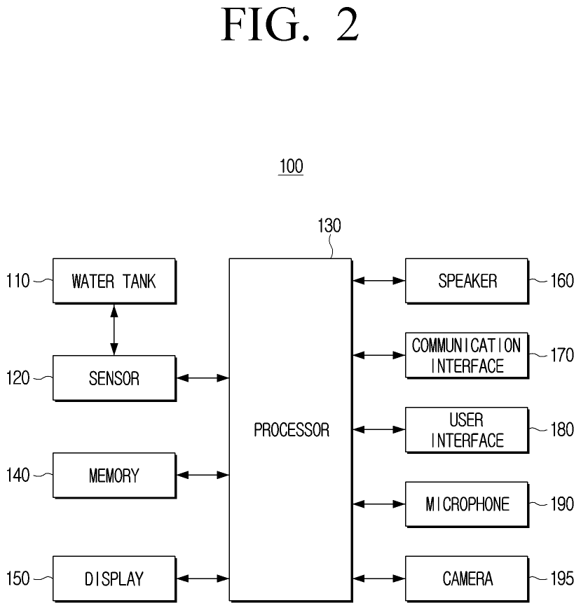

FIG. 2 is a block diagram illustrating a detailed configuration of the electronic apparatus 100 according to an embodiment of the disclosure. The electronic apparatus 100 may include the water tank 110, the sensor 120, and the processor 130. In addition, referring to FIG. 2, the electronic apparatus 100 may further include a memory 140, a display 150, a speaker 160, a communication interface 170, a user interface 180, a microphone 190, and a camera 195. Detailed description of parts that overlap with the elements shown in FIG. 1 from among the elements shown in FIG. 2 will be omitted.

The memory 140 may refer to a hardware that stores information such as data in electric or magnetic form for the processor 130 and the like to access. To this end, the memory 140 may be implemented as at least one hardware from among a non-volatile memory, a volatile memory, a flash memory, a hard disk drive (HDD) or a solid state drive (SSD), a random access memory (RAM), a read only memory (ROM), and the like.

In the memory 140, at least one instruction necessary in an operation of the electronic apparatus 100 or the processor 130 may be stored. Here, the instruction may be a code unit that instructs an operation of the electronic apparatus 100 or the processor 130, and may be prepared in a machine language which is a language that can be understood by a computer. Alternatively, the memory 140 may be stored with a plurality of instructions which perform a specific work of the electronic apparatus 100 or the processor 130 as an instruction set.

The memory 140 may be stored with data which is information in a bit or byte unit that can represent a character, a number, an image, and the like. For example, the memory 140 may be stored with a guide message providing module, a water tank managing module, a water tank managing function control module, and the like.

The memory 140 may be accessed by the processor 130, and reading, writing, modifying, deleting, updating, and the like of the instruction, the instruction set, or data may be performed by the processor 130.

The display 150 may be a configuration that displays an image, and implemented as a display of various forms such as a liquid crystal display (LCD), an organic light emitting diode (OLED) display, and a plasma display panel (PDP). In the display 150, a driving circuit, which may be implemented in the form of an a-si TFT, a low temperature poly silicon (LTPS) TFT, an organic TFT (OTFT), or the like, a backlight unit, and the like may be included. Meanwhile, the display 150 may be implemented as a touch screen coupled with a touch sensor, a flexible display, a three-dimensional display (3 D display), or the like.

The speaker 160 may be an element that outputs not only various audio data processed in the processor 130, but also various notification sounds, voice messages, or the like.

The communication interface 170 may be a configuration that performs communication with external devices of various types according to communication methods of various types. For example, the electronic apparatus 100 may perform communication with a user terminal device or a server through the communication interface 170.

The communication interface 170 may include a Wi-Fi module, a Bluetooth module, an infrared communication module, a wireless communication module, and the like. Here, each communication module may be implemented in at least one hardware chip form.

The Wi-Fi module and the Bluetooth module may perform communication in a Wi-Fi method and a Bluetooth method, respectively. When using the Wi-Fi module or the Bluetooth module, various connection information such as a service set identifier (SSID) and a session key may first be transmitted and received, and after communicatively joining using the same, various information may be transmitted and received. The infrared communication module may perform communication according to an infrared communication (Infrared Data Association (IrDA)) technology of transmitting data wirelessly in short range by using infrared rays present between visible rays and millimeter waves.

The wireless communication module may include at least one communication chip that performs communication according to various wireless communication standards such as, for example, and without limitation, ZigBee, 3rd Generation (3G), 3rd Generation Partnership Project (3GPP), Long Term Evolution (LTE), LTE Advanced (LTE-A), 4th Generation (4G), 5th Generation (5G), and the like, in addition to the above-described communication methods.

Alternatively, the communication interface 170 may include a wired communication interface such as, for example, and without limitation, HDMI, DP, Thunderbolt, USB, RGB, D-SUB, DVI, and the like.

In addition thereto, the communication interface 170 may include at least one of wired communication modules that perform communication using a local area network (LAN) module, an Ethernet module, or a pair cable, a coaxial cable or an optical fiber cable, or the like.

The user interface 110 may be implemented as a button, a touch pad, a mouse, a keyboard, and the like, or implemented as a touch screen capable of performing a display function and an operation input function together therewith. Here, the button may be a button of various types such as a mechanical button, a touch pad, or a wheel which is formed at a random area at a front surface part or a side surface part, a rear surface part, or the like of an exterior of a main body of the remote control apparatus 100.

The microphone 190 may be a configuration for receiving sound and converting to an audio signal. The microphone 190 may be electrically connected with the processor 130, and may receive sound by the control of the processor 130.

For example, the microphone 190 may be formed as an integrated-type integrated to an upper side or a front surface direction, a side surface direction or the like of the electronic apparatus 100. Alternatively, the microphone 190 may be provided in a remote controller, or the like separate from the electronic apparatus 100. In this case, the remote controller may receive sound through the microphone 190, and provide the received sound to the electronic apparatus 100.

The microphone 190 may include various configurations such as a microphone that collects sound of an analog form, an amplifier circuit that amplifies the collected sound, an A/D converter circuit that samples the amplified sound and converts to a digital signal, a filter circuit that removes noise components from the converted digital signal, and the like.

The microphone 190 may be implemented in a form of a sound sensor, and may be any method so long as it is a configuration that can collect sound.

The camera 195 may be a configuration for capturing a still image or a moving image. The camera 195 may capture the still image at a specific time point, but may also capture the still image consecutively.

The camera 195 may capture one direction of the electronic apparatus 100. A guide message may be provided if the user is identified from a captured image captured through the camera 195.

The camera 195 may include a lens, a shutter, an aperture, a solid-state imaging device, an Analog Front End (AFE), and a Timing Generator (TG). The shutter may be configured to adjust a time during which light reflected from a subject enters the camera 195, and the aperture may be configured to adjust an amount of light incident to the lens by mechanically increasing or decreasing a size of an opening part through which light enters. The solid-state imaging device may be configured to output, based on light reflected from the subject being accumulated as photo charge, an image by the photo charge as an electric signal. The TG may be configured to output a timing signal for reading out pixel data of the solid-state imaging device, and the AFE may be configured to digitalize the electric signal output from the solid-state imaging device by sampling.

As described above, the electronic apparatus 100 may maintain the water tank 110 in a clean state by providing a guide message for managing the water tank 110.

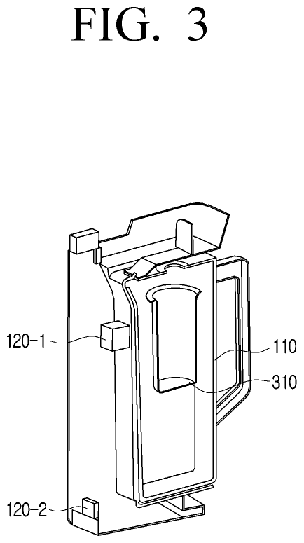

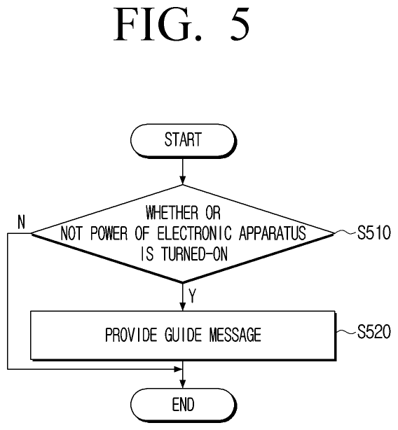

An operation of the electronic apparatus 100 will be described in greater detail below through FIG. 3 to FIG. 8. In FIG. 3 to FIG. 8, separate embodiments will be described for convenience of description. However, the separate embodiments of FIG. 3 to FIG. 8 may be implemented in any combined state. Specifically, the separate embodiments of FIG. 5 to FIG. 8 may be such that any one thereof may be a pre-condition and the other may be an operation according to fulfillment of the condition, and various embodiments thereof will be described below through the drawings.

FIG. 3 is a diagram illustrating a system associated with an autofill function according to an embodiment of the disclosure.

The electronic apparatus 100 may include the water tank 110. For example, the electronic apparatus 100 may include the first water tank for providing water to the user as shown in FIG. 3.

The electronic apparatus 100 may further include the weight sensor disposed at a lower part of the first water tank, and the processor 130 may identify whether or not the first water tank is mounted based on a signal of the weight sensor. The processor 130 may supply, based on the first water tank being identified as mounted, water to the first water tank through an infuser 310. Here, the water supplied to the first water tank may be water stored in the second water tank.

The electronic apparatus 100 may further include a water level sensor 120-1 disposed at a surrounding of the first water tank, and the processor 130 may identify a water level of the first water tank based on a signal of the water level sensor 120-1. For example, the electronic apparatus 100 may further include the water level sensor 120-1 near an upper end of the first water tank, and the processor 130 may stop supplying water to the first water tank when the water level of the first water tank is identified as greater than or equal to a threshold water level based on the signal of the water level sensor 120-1.

However, the above is not limited thereto, and the processor 130 may indirectly identify the water level of the first water tank based on the signal of the weight sensor, and stop supplying water to the first water tank when weight of the first water tank is identified as greater than or equal to a threshold weight.

Alternatively, the electronic apparatus 100 may include a plurality of water level sensors disposed at predetermined height intervals, and the processor 130 may identify the water level of the first water tank based on sensors through which water is sensed from among the plurality of water level sensors. The processor 130 may stop, based on water being sensed from all of the plurality of water level sensors, supplying water to the first water tank.

The electronic apparatus 100 may further include an overflow sensor 120-2, and the processor 130 may identify whether or not water of the first water tank has overflowed based on a signal of the overflow sensor 120-2. The processor 130 may provide, based on the water of the first water tank being identified as overflowed based on the signal of the overflow sensor 120-2, a guide message guiding that the water has overflowed.

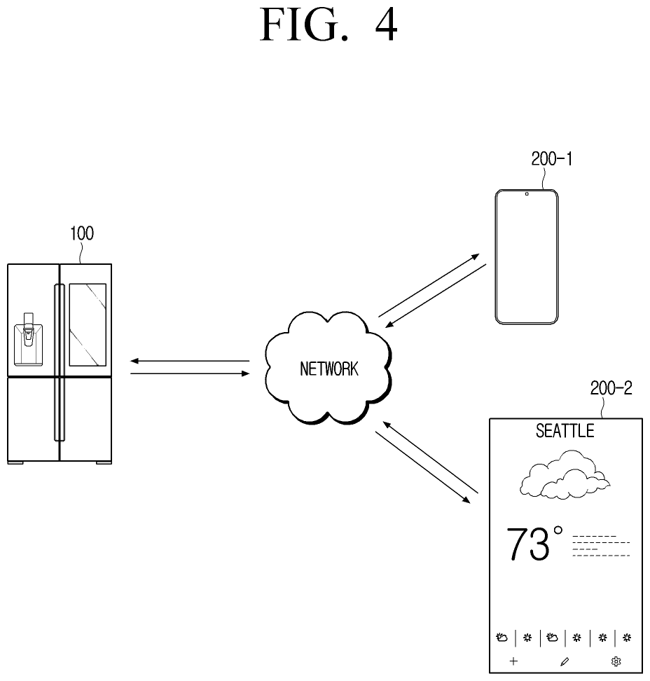

FIG. 4 is a diagram illustrating a system providing a guide message according to an embodiment of the disclosure.

The processor 130 may display the guide message or output the guide message in sound for managing the water tank 110.

Alternatively, the processor 130 may transmit a guide message for managing the water tank 110 to a user terminal device 200-1 or another home appliance 200-2 being used by the user as shown in FIG. 4.

For example, the processor 130 may request, based on providing a guide message for managing the water tank 110, an operation state of another home appliance connected to a same network as with the electronic apparatus 100. The processor 130 may receive the operation state of another home appliance connected with the same network, identify the home appliance being used by the user, and provide a guide message to the identified home appliance.

However, the above is not limited thereto, and the processor 130 may provide, based on providing a guide message for managing the water tank 110, a guide message to another home appliance connected to the same network as with the electronic apparatus 100. In this case, a home appliance which is turned-on and not in a standby mode from among other home appliances connected to the same network may be provided with a guide message, and a home appliance which is in the standby mode may not be provided with a guide message.

FIG. 5 to FIG. 8 are flowcharts illustrating an operation of providing a guide message according to various embodiments of the disclosure. In FIG. 5 to FIG. 8, the water tank for providing water to the user will be described as the first water tank, and the water tank for providing water to each configuration of the electronic apparatus 100 will be described as the second water tank. In addition, the second water tank may be assumed as employing the non-plumbing method. According to an embodiment, the electronic apparatus 100 may include only the first water tank, include only the second water tank, or include both the first water tank and the second water tank.

First, the processor 130 may identify whether or not power of the electronic apparatus 100 is turned-on (S510) as shown in FIG. 5. The processor 130 may provide a guide message (S520) if the electronic apparatus 100 is turned-on, and may not perform any operation if the electronic apparatus 100 is not turned-on.

For example, the processor 130 may provide a guide message such as “When using the autofill water purifier, please set the autofill water purifier to on and periodically clean the first water tank.” if the electronic apparatus 100 is turned-on. In addition, the processor 130 may provide a guide message such as “When using the autofill water purifier, please set the autofill water purifier to on and periodically clean the first water tank.” to the user terminal device if the electronic apparatus 100 is turned-on and connected to the internet.

Alternatively, the processor 130 may provide a guide message such as “When using the ice maker function, please periodically clean the second water tank.” if the electronic apparatus 100 is turned-on. In addition, the processor 130 may provide a guide message such as “When using the ice maker function, please periodically clean the second water tank.” to the user terminal device if the electronic apparatus 100 is turned-on and connected to the internet.

Alternatively, the processor 130 may provide a guide message such as “When using the autofill water purifier, please set the autofill water purifier to on and periodically clean the first water tank and the second water tank.” if the electronic apparatus 100 is turned-on. In addition, the processor 130 may provide a guide message such as “When using the autofill water purifier, please set the autofill water purifier to on and periodically clean the first water tank. When using the ice maker function, please periodically clean the second water tank.” to the user terminal device if the electronic apparatus 100 is turned-on and connected to the internet.

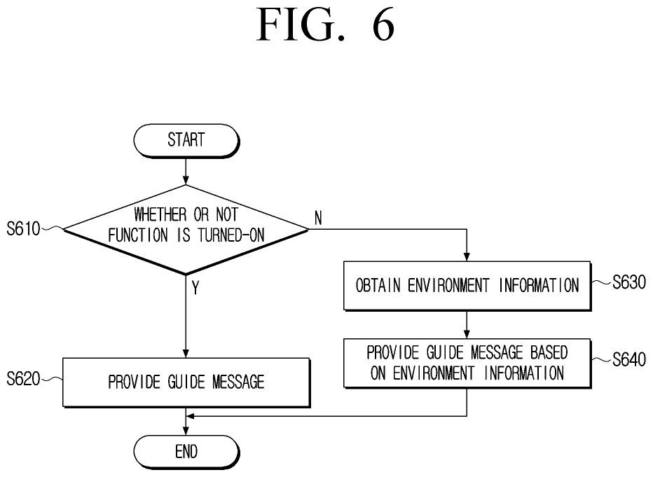

The processor 130 may provide a guide message based on whether or not a function is turned-on as shown in FIG. 6. First, the processor 130 may identify whether or not a function is turned-on (S610). The processor 130 may provide a guide message based on the function being turned-on (S620), obtain environment information based on the function being turned-off (S630), and provide a guide message based on the environment information (S640).

For example, the processor 130 may identify whether or not the autofill function associated with the first water tank is turned-on, and provide a guide message such as “When using the autofill water purifier, please periodically clean the first water tank.” if the autofill function is turned-on.

However, the above is not limited thereto, and the processor 130 may identify a history of having provided the guide message if the autofill function is turned-on, and determine whether or not to provide a guide message based on the history of having provided the guide message. For example, the processor 130 may not provide a guide message if there is history of having provided the guide message within 1 day of the autofill function being turned-on, and provide a guide message such as “When using the autofill water purifier, please periodically clean the first water tank.” if there is no history of having provided the guide message within 1 day of the autofill function being turned-on.

Alternatively, the processor 130 may identify the temperature and humidity outside the electronic apparatus 100 if the autofill function is turned-off, and reduce a guide message providing period based on at least one of the temperature being greater than or equal to the threshold temperature, or the humidity being greater than or equal to the threshold humidity. For example, the processor 130 may maintain the guide message providing period to 15 days if the temperature is less than the threshold temperature, and the humidity is less than the threshold humidity. Then, the processor 130 may reduce the guide message providing period to 5 days based on at least one of the temperature being greater than or equal to the threshold temperature, or the humidity being greater than or equal to the threshold humidity.

However, the above is not limited thereto, and the processor 130 may provide a guide message if the autofill function is turned-off, and change the guide message providing period based on the environment information thereafter. For example, the processor 130 may provide a guide message such as “Please periodically clean the first water tank.” if the autofill function is turned-off, and change the guide message providing period based on the environment information. Here, the processor 130 may provide a message such as “When not using the autofill function, please clean the first water tank.” based on the changed period after providing the guide message such as “Please periodically clean the first water tank.”

Meanwhile, the processor 130 may provide a guide message according to whether or not another function other than the autofill function is turned-on with respect to the second water tank.

For example, the processor 130 may identify whether or not the function using the ice maker included in the electronic apparatus 100 is turned-on by using the water supplied from the second water tank, and provide a guide message such as “When using the ice maker function, please periodically clean the second water tank.” if the ice maker function is turned-on.

However, the above is not limited thereto, and the processor 130 may identify the history of having provided the guide message if the ice maker function is turned-on, and determine whether or not to provide the guide message based on the history of having provided the guide message. For example, the processor 130 may not provide a guide message if there is history of having provided the guide message within 1 day of the ice maker function being turned-on, and provide a guide message such as “When using the ice maker function, please periodically clean the second water tank,” if there is no history of having provided the guide message within 1 day of the ice maker function being turned-on.

Alternatively, the processor 130 may identify the temperature and humidity outside the electronic apparatus 100 if the ice maker function is turned-off, and reduce the guide message providing period based on at least one of the temperature being greater than or equal to the threshold temperature or the humidity being greater than or equal to the threshold humidity. For example, the processor 130 may maintain the guide message providing period to 15 days if the temperature is less than the threshold temperature and the humidity is less than the threshold humidity. Then, the processor 130 may reduce the guide message providing period to 5 days based on at least one of the temperature being greater than or equal to the threshold temperature or the humidity being greater than or equal to the threshold humidity.

However, the above is not limited thereto, and the processor 130 may provide a guide message if the ice maker function is turned-off, and change the guide message providing period based on the environment information thereafter. For example, the processor 130 may provide a guide message such as “Please periodically clean the second water tank.” if the ice maker function is turned-off, and change the guide message providing period based on the environment information. Here, the processor 130 may provide a message such as “When not using the ice maker, please clean the second water tank.” based on the changed period after providing the guide message such as “Please periodically clean the second water tank.”

As described in FIG. 6, the processor 130 may identify a function based on a type of the water tank, and provide a guide message based on whether or not the function is turned-on.

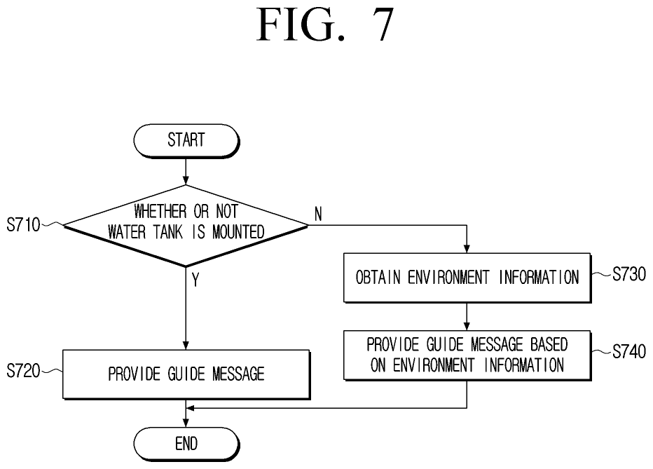

The processor 130 may also provide a guide message based on whether or not the water tank 110 is mounted as shown in FIG. 7. First, the processor 130 may identify whether or not the water tank 110 is mounted (S710).

The processor 130 may provide a guide message if the water tank 110 is mounted (S720), obtain environment information if the water tank 110 is not mounted (S730), and provide a guide message based on the environment information (S740).

For example, the processor 130 may identify whether or not the first water tank is mounted, and provide a guide message such as “Please periodically clean the first water tank.” if the first water tank is mounted. However, the above is not limited thereto, and the processor 130 may identify whether or not the first water tank is mounted, and provide the guide message such as “Please periodically clean the first water tank.” only when a threshold time has passed from a previous mounting time-point if the first water tank is mounted. That is, if a use time of the first water tank is short, a guide message may not be provided, and a guide message may be provided on when the use time of the first water tank is quite long.

Alternatively, the processor 130 may identify the temperature and humidity outside the electronic apparatus 100 if the first water tank is not mounted, and reduce the guide message providing period based on at least one of the temperature being greater than or equal to the threshold temperature or the humidity being greater than or equal to the threshold humidity. For example, the processor 130 may maintain the guide message providing period to 12 hours if the temperature is less than the threshold temperature and the humidity is less than the threshold humidity. Then, the processor 130 may reduce the guide message providing period to 6 hours based on at least one of the temperature being greater than or equal to the threshold temperature or the humidity being greater than or equal to the threshold humidity. In this case, the processor 130 may provide a guide message such as “When not using the first water tank, please store the first water tank in the electronic apparatus.”

Meanwhile, the processor 130 may identify whether or not the first water tank is mounted based on whether or not the autofill function is turned-on. For example, the processor 130 may identify whether or not the first water tank is mounted only when the autofill function is turned-on.

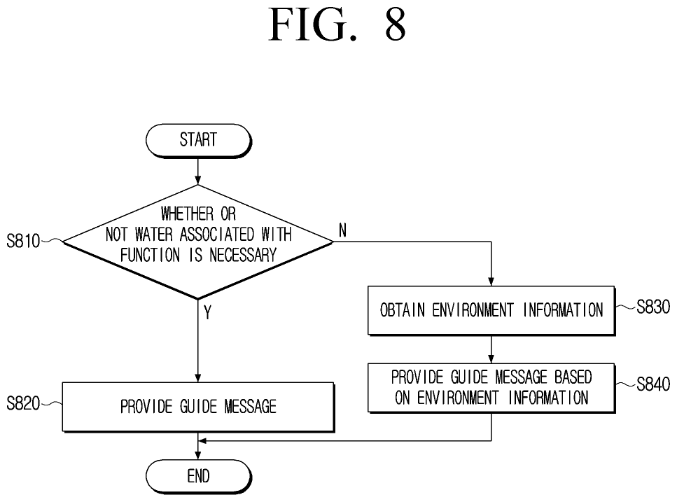

The processor 130 may provide a guide message based on whether or not water associated with a function is necessary as shown in FIG. 8. First, the processor 130 may identify whether or not water associated with a function is necessary (S810).

The processor 130 may provide a guide message (S820) if water associated with the function is identified as necessary, obtain environment information (S830) if the water associated with the function is identified as unnecessary, and provide a guide message based on the environment information (S840).

For example, the processor 130 may provide a guide message such as “Please periodically clean the first water tank.” if water is necessary due to the water of the first water tank not being in a full state with respect to the autofill function. That is, the processor 130 may guide a cleaning of the first water tank prior to additionally supplying water to the first water tank.

However, the above is not limited thereto, and the processor 130 may provide a guide message based on whether or not the first water tank just prior to was full if water is necessary due to the water of the first water tank not being in the full state with respect to the autofill function. For example, the processor 130 may provide a guide message such as “Please periodically clean the first water tank.” based on the first water tank just prior to being in the full state if water is necessary due to the water of the first water tank not being in the full state with respect to the autofill function. Alternatively, the processor 130 may provide a guide message based on the history of having provided the guide message within 7 days based on the first water tank just prior to not being in the full state if water is necessary due to the water of the first water tank not being in the full state with respect to the autofill function. The processor 130 may not provide the guide message if there is history of having provided the guide message within 7 days, and may provide a guide message such as “Please periodically clean the first water tank.” if there is no history of having provided the guide message within 7 days.

Meanwhile, the processor 130 may identify, based on the water not being necessary due to the water of the first water tank being in the full state with respect to the autofill function, the temperature and humidity outside the electronic apparatus 100, and reduce the guide message providing period based on at least one of the temperature being greater than or equal to the threshold temperature or the humidity being greater than or equal to the threshold humidity. For example, the processor 130 may maintain the guide message providing period to 30 days if the temperature is less than the threshold temperature and the humidity is less than the threshold humidity. Then, the processor 130 may reduce the guide message providing period to 15 days based on at least one of the temperature being greater than or equal to the threshold temperature or the humidity being greater than or equal to the threshold humidity. Through the operation described above, the processor 130 may prevent water from being contained in the first water tank for a long period of time.

Meanwhile, the processor 130 may identify whether or not water is necessary in the first water tank based on whether or not the first water tank is mounted. For example, the processor 130 may identify whether or not water is necessary in the first water tank only when the first water tank is mounted.

Meanwhile, the processor 130 may provide a guide message according to whether or not water is necessary in another function which is not the autofill function with respect to the second water tank.

For example, the processor 130 may provide a guide message such as “Please periodically clean the second water tank.” if water is necessary for not being in a full ice state with respect to the ice maker function. That is, the processor 130 may guide a cleaning of the second water tank prior to additionally supplying water to an ice maker mold.

However, the above is not limited thereto, and the processor 130 may provide a guide message based on the history of having provided the guide message within 7 days if water is necessary for not being in the full ice state with respect to the ice maker function. The processor 130 may not provide the guide message if there is history of having provided the guide message within 7 days, and may provide a guide message such as “Please periodically clean the second water tank.” if there is no history of having provided the guide message within 7 days.

Meanwhile, the processor 130 may identify, based on water not being necessary for being in the full ice state with respect to the ice maker function, the temperature and humidity outside the electronic apparatus 100, and reduce guide message providing period based on at least one of the temperature being greater than or equal to the threshold temperature or the humidity being greater than or equal to the threshold humidity. For example, the processor 130 may maintain the guide message providing period to 30 days if the temperature is less than the threshold temperature and the humidity is less than the threshold humidity. Then, the processor 130 may reduce the guide message providing period to 15 days based on at least one of the temperature being greater than or equal to the threshold temperature or the humidity being greater than or equal to the threshold humidity. Through the operation described above, the processor 130 may prevent the ice from being contained in the ice maker mold for a long period of time.

Meanwhile, the processor 130 may identify whether or not water is necessary in the ice maker function based on whether or not the ice maker function is turned-on. For example, the processor 130 may identify whether or not water is necessary in the ice maker function only when the ice maker function is turned-on.

Meanwhile, the time mentioned in FIG. 5 to FIG. 8 (ex: 15 days, 30 days, etc.) may be used with any other time.

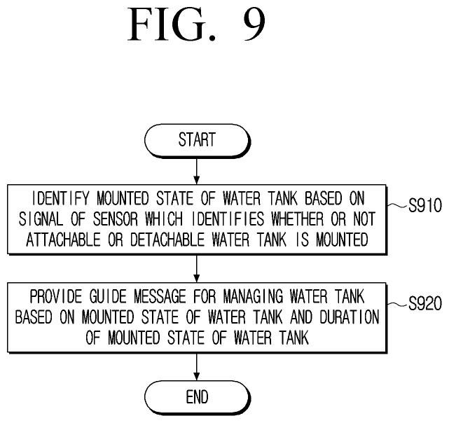

FIG. 9 is a flowchart illustrating a control method of an electronic apparatus according to an embodiment of the disclosure.

First, the mounted state of the water tank may be identified based on a signal of a sensor which identifies whether or not an attachable or detachable water tank is mounted (S910). Then, a guide message for managing the water tank may be provided based on the mounted state of the water tank and the duration of the mounted state of the water tank (S920).

In addition, the providing of the guide message (S920) may include providing the first guide message for managing the water tank if the first time is passed without the water tank mounted to the electronic apparatus, and providing the second guide message for managing the water tank if the second time is passed with the water tank mounted to the electronic apparatus.

Then, the sensor may include the first sensor configured to identify whether or not the water tank is mounted and the second sensor configured to identify the temperature and humidity outside the electronic apparatus, and the control method may further include identifying the temperature and humidity outside the electronic apparatus based on the signal of the second sensor and changing the first time to the third time which is shorter than the first time based on at least one of the temperature being greater than or equal to the threshold temperature or the humidity being greater than or equal to the threshold humidity.

In addition, the sensor may further include the third sensor configured to identify the water level of the water tank, and the providing of the guide message (S920) may include providing the second guide message if the fourth time is passed with the water level of the water tank being greater than or equal to the threshold value based on the signal of the third sensor, and providing the third guide message for managing the water tank if the fifth time which is longer than the fourth time is passed with the water level of the water tank being greater than or equal to the threshold value.

Then, the control method may further include identifying the execution state of the first function which is the function for supplying water to the water tank, and the providing of the guide message (S920) may include providing a guide message if the execution state of the first function is changed.

In addition, the providing of the guide message (S920) may include providing the first guide message for managing the water tank if the first function is turned-on and the first time is passed with the water tank being in the first state, providing the second guide message for managing the water tank if the first function is turned-on and the second time is passed with the water tank in the second state, and providing the second guide message if the first function is turned-off.

Further, the water tank may include the first water tank and the second water tank, and the control method may further include identifying the execution state of the first function which is the function for supplying water from the second water tank to the first water tank and providing another guide message for managing the second water tank if the execution state of the first function is changed.

In addition, the control method may further include identifying the execution state of the second function which is the function for supplying water to configurations included in the electronic apparatus from the second water tank, and the providing another guide message may include providing another guide message if the execution state of the second function is changed.

Further, the second function may be the function for using the ice maker included in the electronic apparatus by using the water supplied from the second water tank, and the providing another guide message may include providing another guide message based on the ice generated by the ice maker.

In addition, the providing of the guide message (S920) may include displaying the guide message through the display included in the electronic apparatus, or outputting the guide message in sound through the speaker included in the electronic apparatus.

Then, the providing of the guide message (S920) may include transmitting the guide message to the user terminal device.

According to the various embodiments of the disclosure as described above, the electronic apparatus may provide a guide message for managing the water tank, and maintain the water tank in a clean state.

Meanwhile, according to an embodiment of the disclosure, the various embodiments described above may be implemented with software which includes instructions stored in a machine-readable storage medium (e.g., computer). The machine may call an instruction stored in the storage medium, and as a device operable according to the called instruction, may include an electronic apparatus (e.g., electronic apparatus (A)) according to the above-mentioned embodiments. Based on an instruction being executed by the processor, the processor may directly or using other elements under the control of the processor perform a function corresponding to the instruction. The instruction may include a code generated by a compiler or executed by an interpreter. The machine-readable storage medium may be provided in the form of a non-transitory storage medium. Herein, ‘non-transitory’ merely means that the storage medium is tangible and does not include a signal, and the term does not differentiate data being semi-permanently stored or being temporarily stored in the storage medium.

In addition, according to an embodiment of the disclosure, a method according to the various embodiments described above may be provided included a computer program product. The computer program product may be exchanged between a seller and a purchaser as a commodity. The computer program product may be distributed in the form of a machine-readable storage medium (e.g., a compact disc read only memory (CD-ROM)), or distributed online through an application store (e.g., PLAYSTORE™). In the case of online distribution, at least a portion of the computer program product may be stored at least temporarily in the storage medium such as a server of a manufacturer, a server of an application store, or a memory of a relay server, or temporarily generated.

In addition, according to an embodiment of the disclosure, the various embodiments described above may be implemented in a recordable medium which is readable by a computer or a device similar to the computer using software, hardware, or the combination of software and hardware. In some cases, embodiments described herein may be implemented by the processor on its own. According to a software implementation, embodiments such as the procedures and functions described herein may be implemented as separate software modules. Each software may perform one or more functions and operations described herein.

Meanwhile, the computer instructions for performing processing operations in the device according to the various embodiments described above may be stored in a non-transitory computer-readable medium. The computer instructions stored in this non-transitory computer-readable medium may cause a specific device to perform a processing operation of the device according to the above-described various embodiments when executed by a processor of the specific device. The non-transitory computer-readable medium may refer to a medium that stores data semi-permanently rather than storing data for a very short time, such as a register, a cache, a memory, or the like, and is readable by a device. Specific examples of the non-transitory computer-readable medium may include, for example, and without limitation, a compact disc (CD), a digital versatile disc (DVD), a hard disc, a Blu-ray disc, a USB, a memory card, a ROM, and the like.

In addition, each element (e.g., a module or a program) according to the various embodiments described above may be formed of a single entity or a plurality of entities, and some sub-elements of the above-mentioned sub-elements may be omitted or other sub-elements may be further included in the various embodiments. Alternatively or additionally, some elements (e.g., modules or programs) may be integrated into one entity and perform the same or similar functions performed by each of the corresponding elements prior to integration. Operations performed by a module, a program, or other element, in accordance with the various embodiments, may be executed sequentially, in parallel, repetitively, or in a heuristically manner, or at least some operations may be performed in a different order, omitted, or a different operation may be added.

While the disclosure has been illustrated and described with reference to various embodiments thereof, it will be understood that the various embodiments are intended to be illustrative, not limiting. It will be understood by those skilled in the art that various changes in form and details may be made therein without departing from the true spirit and full scope of the disclosure, including the appended claims and their equivalents.

What is claimed is:

1. An electronic apparatus, comprising:
a water tank that is mountable to the electronic apparatus;
a water tank mount sensor configured to output a signal indicating whether the water tank is mounted to the electronic apparatus; and
at least one processor configured to:
identify a mounted state of the water tank based on the signal output by the water tank mount sensor, and
provide a guide message for a user for managing the water tank, based on the identified mounted state and a duration of the mounted state.

2. The electronic apparatus of claim 1, wherein
the at least one processor is configured to:
based on a first duration time being passed with the identified mounted state being a state that the water tank is not mounted to the electronic apparatus, provide a first guide message for the user for managing the water tank, and
based on a second duration time being passed with the identified mounted state being a state that the water tank is mounted to the electronic apparatus, provide a second guide message for the user for managing the water tank.

3. The electronic apparatus of claim 2, further comprising:
an environment sensor configured to output a signal indicating temperature and humidity outside the electronic apparatus,
wherein the at least one processor is configured to:
identify the temperature and humidity outside the electronic apparatus based on the signal output by the environment sensor, and
based on at least one of the identified temperature being greater than a threshold temperature and the identified humidity being greater than a threshold humidity, change the first duration time to a third duration time being passed with the identified mounted state being a state that the water tank is not mounted, the third duration time being shorter than the first duration time.

4. The electronic apparatus of claim 3, further comprising:
a water level sensor configured to output a signal indicating a water level of the water tank, and
the processor is configured to:
identify the water level of the water tank based on the signal output by the water level sensor,
based on a fourth duration time being passed with the identified mounted state being a state that the identified water level of the water tank is greater than a threshold value, provide the second guide message for the user for managing the water tank, and
based on a fifth duration time being passed with the identified mounted state being a state that the identified water level of the water tank is greater than the threshold value, the fifth duration time being longer than the fourth duration time, provide a third guide message for the user for managing the water tank.

5. The electronic apparatus of claim 1, wherein
the processor is configured to:
identify an execution state of a first function which is a function for supplying water to the water tank, and
based on the execution state of the first function being changed, provide the guide message for the user for managing the water tank.

6. The electronic apparatus of claim 5, wherein
the processor is configured to:
based on the first function being turned-on and a first duration time being passed with the identified mounted state being a first state, provide a first guide message for the user for managing the water tank,
based on the first function being turned-on and a second duration time being passed with the identified mounted state being a second state, provide a second guide message for the user for managing the water tank, and
based on the first function being turned-off, provide the second guide message for the user for managing the water tank.

7. The electronic apparatus of claim 1, wherein
the water tank that is mountable to the electronic apparatus is a first water tank,
the electronic apparatus further comprises a second water tank, and
the at least one processor is configured to:
identify an execution state of a first function which is a function for supplying water from the second water tank to the first water tank, and
provide a guide message for a user for managing the second water tank based on the execution state of the first function being changed.

8. The electronic apparatus of claim 7, wherein
the processor is configured to:
identify an execution state of a second function which is a function for supplying water from the second water tank to another configuration in the electronic apparatus, and
based on the execution state of the second function being changed, provide the guide message for the user for managing the second water tank.

9. The electronic apparatus of claim 8, wherein
the second function is a function for using an ice maker in the electronic apparatus by using water supplied from the second water tank, and
the processor is configured to:
provide the guide message for the user for managing the second water tank based on ice generated by the ice maker.

10. The electronic apparatus of claim 1, further comprising:
a display; and
a speaker,
wherein the processor is configured to:
display the guide message through the display, and/or
output the guide message in sound through the speaker.

11. The electronic apparatus of claim 1, further comprising:
a communication interface,
wherein the processor is configured to:
control the communication interface to transmit the guide message to a user terminal device.

12. A control method of an electronic apparatus including a water tank that is mountable to the electronic apparatus and a water tank mount sensor configured to output a signal indicating whether the water tank is mounted to the electronic apparatus, the method comprising, by the electronic apparatus:
identifying a mounted state of a water tank based on the signal output by the water tank mount sensor; and
providing a guide message for a user for managing the water tank, based on the identified mounted state and a duration of the mounted state.

13. The method of claim 12, wherein
the providing of the guide message includes:
based on a first duration time being passed with the identified mounted state being a state that the water tank is not mounted to the electronic apparatus, providing a first guide message for the user for managing the water tank, and
based on a second duration time being passed with the identified mounted state being a state that the water tank is mounted to the electronic apparatus, providing a second guide message for the user for managing the water tank.

14. The method of claim 13, wherein the electronic apparatus includes an environment sensor configured to output a signal indicating temperature and humidity outside the electronic apparatus, and the method further comprises, by the electronic apparatus:
identifying the temperature and humidity outside the electronic apparatus based on the signal output by the environment sensor; and
based on at least one of the identified temperature being greater than a threshold temperature and the identified humidity being greater than a threshold humidity, changing the first duration time to a third duration time being passed with the identified mounted state being a state that the water tank is not mounted, the third duration time being shorter than the first duration time.

15. The method of claim 14, wherein the electronic apparatus includes a water level sensor configured to output a signal indicating a water level of the water tank, and the method further comprises, by the electronic apparatus:
identifying the water level of the water tank based on the signal output by the water level sensor;
based on a fourth duration time being passed with the identified mounted state being a state that the identified water level of the water tank is greater than a threshold value, providing the second guide message for the user for managing the water tank; and
based on a fifth duration time being passed with the identified mounted state being a state that the identified water level of the water tank is greater than the threshold value, providing a third guide message for the user for managing the water tank.
